(19) United States
(12) Patent Application Publication
(10) Pub. No.: US 2005/0280543 A1
(43) Pub. Date: Dec. 22, 2005

(54) Serial bus identification circuit for a computer chip enclosed in a stainless steel can

(75) Inventor: Edmund E. Herbert, Charlotte, NC (US)

Correspondence Address: DOUGHERTY, CLEMENTS, HOFER, BERNARD & WALKER, 1901 ROXBOROUGH ROAD, SUITE 300, CHARLOTTE, NC, 28211, US

(73) Assignee: Marcon International, Inc., Harrisburg, NC (US)

(21) Appl. No.: 11/211,054

(22) Filed: Aug. 24, 2005

Related U.S. Application Data
(63) Continuation-in-part of application No. 10/996,687, filed on Nov. 24, 2004.
(60) Provisional application No. 60/481,700, filed on Nov. 25, 2003.

(51) Int. Cl. G08B 13/14; G08B 5/22

(52) U.S. Cl. 340/572.8; 340/825.49; 340/571

(57) ABSTRACT

The present invention provides an electronic activation and identification module that includes a holder device configured to hold an object of interest; a digital device coupled to the holder device, wherein the digital device has a unique digital registration number; a storage receptacle configured to selectively receive the holder device; a light-emitting source coupled to the storage receptacle and associated with the holder device; and an electrical power source. Optionally, the digital device consists of a microprocessor disposed within a protective housing and the light-emitting source comprises a light-emitting diode. Preferably, the digital device is in electrical communication with a serial data bus. The light-emitting source provides an identifying position signal indicating when the holder device is one of being received by the storage receptacle and not being received by the storage receptacle. The electronic activation and identification module may also include a microprocessor operable for selectively illuminating the light-emitting source.

### CROSS-REFERENCE TO RELATED APPLICATIONS

The present application is a continuation-in-part of U.S. patent application Ser. No. 10/996,687, entitled “SERIAL BUS IDENTIFICATION CIRCUIT FOR A COMPUTER CHIP ENCLOSED IN A STAINLESS STEEL CAN,” and filed on Nov. 24, 2004, which claims the benefit of priority of U.S. Provisional Patent Application No. 60/481,700, also entitled “SERIAL BUS IDENTIFICATION CIRCUIT FOR A COMPUTER CHIP ENCLOSED IN A STAINLESS STEEL CAN,” and filed on Nov. 25, 2003, both of which are incorporated in-full by reference herein.

### FIELD OF THE INVENTION

The present invention relates generally to circuit electrical mapping. More specifically, the present invention relates to the detection and identification of digital devices connected to a serial bus.

### BACKGROUND OF THE INVENTION

There are a number of conventional circuit designs for the detection and identification of digital devices that have a unique digital registration number. One such digital device is an iButton® microprocessor (Dallas Semiconductor), which may contain a memory, a real-time clock, a transaction counter, a temperature sensor, and/or the like. The microprocessor is typically connected via a one-wire interface, that is a serial data bus. In order to troubleshoot and repair these circuits, the prior art teaches using a switching network consisting of a matrix to identify the location of a specific digital device.

What is still needed, however, is a system that consists of discreet modular units that may be added as needed, as well as a means for querying a circuit to identify a specific module.

U.S. Pat. No. 6,693,538 (issued to Maloney on Feb. 17, 2004) discloses one specific application of the digital devices described above. Object carriers are provided for use with an object tracking and control system of a type having a storage receptacle with a tray provided with an array of slots for receiving ID tags bearing touch memory devices. A computer-based controller is provided for detecting the absence or presence and identity of ID tags disposed in the slots. The carrier includes a container with an openable panel for placing objects in and removing objects from the carrier. A thin plastic tongue projects from the carrier and bears a touch memory device. Carriers bearing objects to be tracked are placed in the storage receptacle with their tongues extending into the slots of the receptacle. The controller can thus detect and log the removal and replacement of the carrier in the storage receptacle. In one embodiment, the opening and closing of the carrier when it is not stored in the receptacle is detected and logged for tracking access to the carrier in more detail. In general, each of the carriers includes an internal addressable switch having one or more input/output (I/O) ports; an on-board sensor, such as a loop-detector sensor for detecting when an object is removed from the carrier, a reed switch for detecting the opening of the carrier, or another type of sensor depending on the intended use of the system; and a light-emitting diode (LED) attached to the carrier.

What is still needed, however, is a system that is simpler, omitting the internal addressable switch and the one or more I/O ports, and associating the LEDs with the storage receptacle, as opposed to the carriers.

### BRIEF SUMMARY OF THE INVENTION

In various embodiments, the present invention provides an electronic activation and identification system that may be used to selectively enable a microprocessor or microcontroller in order to identify a specific digital device among a plurality of similar digital devices. As described above, typical of such a digital device is an iButton® microprocessor, which belongs to a generic group of microprocessors that are typically disposed within a protective stainless steel can or the like. Each digital device has a unique digital registration number, and comprises an element of a module. The module also includes a dual-addressable switch component having a first switch and a second switch, wherein the dual-addressable switch component has a unique digital address; a light-emitting source; and an electrical power source. The dual-addressable switch component and the digital device are in electrical communication with a serial data bus. When the first switch of the dual-addressable switch component is closed, the digital device may be accessed, and the unique digital registration number may be downloaded and correlated to the dual-addressable switch component. The second switch of the dual-addressable switch component is closed to activate the light-emitting source utilizing the electrical power source. The light-emitting source thereby provides an identifying position signal for the digital device. Typically, the light-emitting source is an LED, and it is flashed on-and-off. The electrical power source may be auxiliary or, if adequate, drawn directly off the bus. The overall system includes a plurality of modules, each including a digital device having a unique digital registration number, an associated dual-addressable switch component having a unique digital address and a first switch and a second switch, a light-emitting source, and an electrical power source.

In various embodiments, the present invention also provides a method for using an electronic activation and identification system. The method includes: selectively closing a first switch of a dual-addressable switch component having a first switch and a second switch, wherein the dual-addressable switch component has a unique digital address, and wherein the dual-addressable switch component is connected to a serial data bus; establishing communication between a database and a digital device, wherein each digital device has a unique digital registration number; querying, downloading, and recording a module for the unique digital registration number of the digital device and its correlation with the unique digital address of dual-addressable switch component; and selectively closing the second switch of the dual-addressable switch component, thereby activating a light-emitting source. Preferably, the method is repeated until the system is fully characterized as to an activation and identification of all digital devices, wherein each digital device has a unique digital registration number, an associated dual-addressable switch component having a unique digital address having a first switch and a second switch; and a light-emitting source. The method may be used to locate a specific digital device by sending a signal along the serial bus to close the second switch of the associated dual-addressable switch component, the second switch then activating the light-emitting source associated with the specific digital device. Optionally, any or all of the digital devices may be taken off-line by opening the associated first switch.

The present invention departs from conventional systems and methods in that it lends itself to be substantially modular, and, in essence, the microprocessor queries the circuit, developing a visual feedback when a specific digital device is detected, and compiling the identity and location of the specific digital device.

In one exemplary embodiment of the present invention, an electronic activation and identification module includes a holder device configured to hold an object of interest; a digital device coupled to the holder device, wherein the digital device has a unique digital registration number; a storage receptacle configured to selectively receive the holder device; a light-emitting source coupled to the storage receptacle and associated with the holder device; and an electrical power source. Optionally, the digital device consists of a microprocessor disposed within a protective housing and the light-emitting source comprises a light-emitting diode. Preferably, the digital device is in electrical communication with a serial data bus. The light-emitting source provides an identifying position signal indicating when the holder device is one of being received by the storage receptacle and not being received by the storage receptacle. The electronic activation and identification module may also include a microprocessor operable for selectively illuminating the light-emitting source.

In another exemplary embodiment of the present invention, an electronic activation and identification method includes providing a holder device configured to hold an object of interest; providing a digital device coupled to the holder device, wherein the digital device has a unique digital registration number; providing a storage receptacle configured to selectively receive the holder device; providing a light-emitting source coupled to the storage receptacle and associated with the holder device; and providing an electrical power source. Optionally, the digital device consists of a microprocessor disposed within a protective housing and the light-emitting source comprises a light-emitting diode. Preferably, the digital device is in electrical communication with a serial data bus. The light-emitting source provides an identifying position signal indicating when the holder device is one of being received by the storage receptacle and not being received by the storage receptacle. The electronic activation and identification method may also include providing a microprocessor operable for selectively illuminating the light-emitting source.

Advantageously, the system described above is simpler than conventional systems, omitting carrier-internal addressable switches and I/O ports, and associating LEDs with a storage receptacle, as opposed to carriers.

### BRIEF DESCRIPTION OF DRAWINGS

The present invention is illustrated and described herein with reference to various drawings, in which like reference numbers denote like system components and/or method steps, and in which:

FIG. 1 is an electronic circuit diagram illustrating, in one exemplary embodiment of the present invention, how a module having a digital device may be activated and identified; and

FIG. 2 is an electronic circuit diagram illustrating, in another exemplary embodiment of the present invention, how a module having a digital device may be activated and identified.

### DETAILED DESCRIPTION OF THE INVENTION

The present invention provides a system of modules, wherein a module is a serial bus identification circuit that enables a microprocessor or microcontroller to activate and identify a specific digital device associated with the module from among a plurality of modules having a plurality of digital devices, all connected to the same serial bus. Furthermore, the circuit of the module enables one to easily identify and locate the specific digital device, as the location has a flashing LED or other type of flashing lamp.

In general, an iButton® microprocessor is a microprocessor enclosed in a 16 mm stainless steel can or the like. Because of this unique and durable stainless steel can, up-to-date information may travel with a person or object wherever they go. The stainless steel can may be mounted virtually anywhere because it is rugged enough to withstand harsh environments, indoors or outdoors. The digital device is durable enough to attach to a key fob, ring, watch, or other personal item, and be used daily for applications, such as access control for buildings, computers, etc.

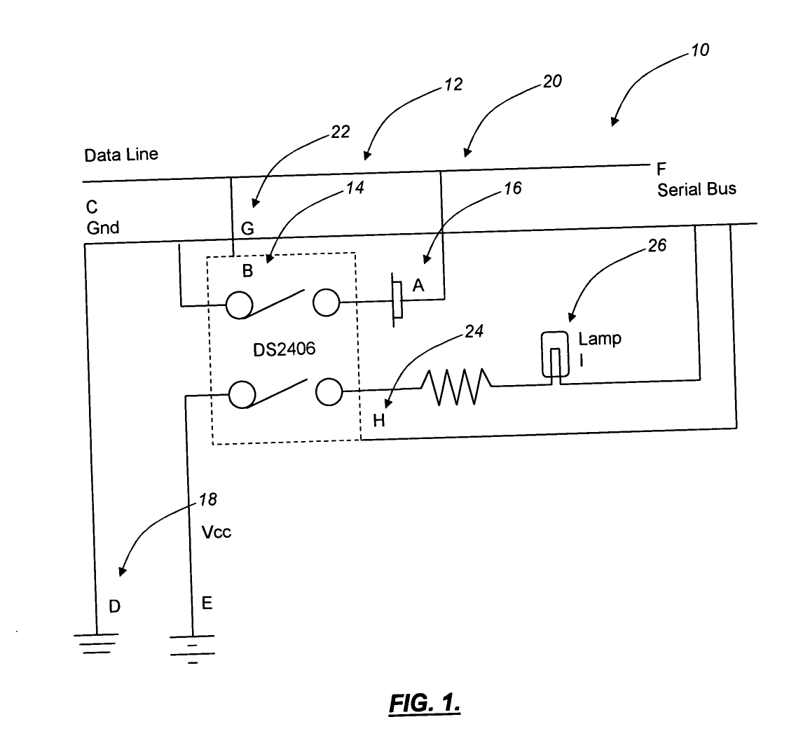

Referring to FIG. 1, in one exemplary embodiment of the serial bus identification circuit module 10 of present invention, attached to the serial bus C 12 is addressable switch B 14, which is a dual-addressable switch component (i.e., DS2406, a product of Dallas Semiconductor) that has a unique digital address. The addressable switch B 14 is connected to an iButton® digital device connector or the like, which is a touch and hold reader or the like. Switch A 16 of the dual-addressable switch component is used to switch the Ground Line D 18 to the ground contact of the digital device connector. The dual-addressable switch component has its own 64-bit ROM registration number that is factory-lasered into the chip to provide a guaranteed unique identity for absolute traceability. The chip has 1024 bits of EPROM that may be used as an electronic label to store information such as switch function, physical location, and installation date. Communication with the dual-addressable switch component follows the standard Dallas Semiconductor 1-Wire Protocol, for example, and may be accomplished with minimal hardware, such as a single port pin of a microcontroller. Multiple dual-addressable switch components may reside on a common one-wire network and be operated independently of one another. Individual chips will respond to a conditional search independently of one another. Also, individual chips will respond to a conditional search command if they qualify for certain user-specified conditions, which include the state of the output transistor, the static logic level, or a voltage transition at the transistor's output.

The data line F 20 is permanently connected to the data side of the digital device connector. The dual-addressable switch component is connected to the serial bus C 12 (see G 22 and H 24). The ability to switch in a specific digital device allows the controller to identify a specific digital device, and then activate switch B 14 of the dual-addressable switch component, which illuminates lamp I 26. Lamp I 26 is, for example, an LED. This identifies the location of the specific digital device. The unique digital address of the dual-addressable switch component may be stored in the controller's memory, and later used to sequentially switch each dual-addressable switch component switch on, and then read in the digital device's unique digital registration number. It should be noted that multiple digital devices may be connected to a one-wire bus and identified by each digital device's unique digital registration number.

The present invention allows the controller to build a database of DS2406 dual-addressable switch components and specific digital devices (i.e., DS1990) connected to the switch contacts on a two-wire serial bus.

The control flow to identify a specific digital device on the serial bus is as follows: switch on the contacts that will connect the DS1990 digital device to the serial bus; read the serial number of the switched-in DS 1990 digital device; switch in the lamp contacts to illuminate the lamp; and repeat the process until a specific DS1990 digital device is found.

In an alternative embodiment, the circuit of the present invention may be changed such that the light-emitting source is connected to the serial bus, as apposed to the VCC connection. This change enables the whole circuit to operate without external power, if the power requirements are met by the bus. Modules may be added directly to the serial bus, essentially like a plug-and-play component on a personal computer (PC).

As described above, U.S. Pat. No. 6,693,538 discloses one specific application of a digital device. Object carriers are provided for use with an object tracking and control system of a type having a storage receptacle with a tray provided with an array of slots for receiving ID tags bearing touch memory devices. A computer-based controller is provided for detecting the absence or presence and identity of ID tags disposed in the slots. The carrier includes a container with an openable panel for placing objects in and removing objects from the carrier. A thin plastic tongue projects from the carrier and bears a touch memory device. Carriers bearing objects to be tracked are placed in the storage receptacle with their tongues extending into the slots of the receptacle. The controller can thus detect and log the removal and replacement of the carrier in the storage receptacle. In one embodiment, the opening and closing of the carrier when it is not stored in the receptacle is detected and logged for tracking access to the carrier in more detail. In general, each of the carriers includes an internal addressable switch having one or more I/O ports; an on-board sensor, such as a loop-detector sensor for detecting when an object is removed from the carrier, a reed switch for detecting the opening of the carrier, or another type of sensor depending on the intended use of the system; and an LED attached to the carrier.

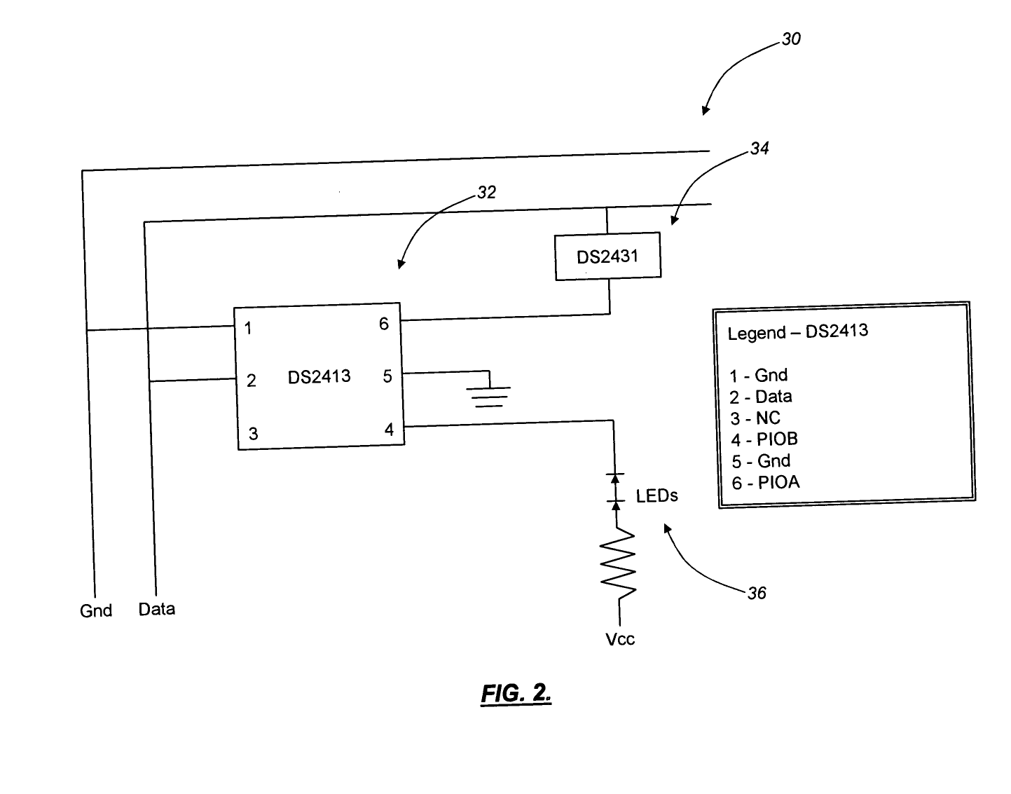

The present invention, however, provides a system that is simpler, omitting the internal addressable switch and the one or more I/O ports, and associating the LEDs with the storage receptacle, as opposed to the carriers. This circuit module 30 is illustrated in FIG. 2. As may be seen, the circuit module 30 includes two chips 32,34 (i.e., DS2413 and DS2431) operable for providing a digital device with a unique digital registration number and selectively lighting one or more LEDs 36 or the like. Various data and ground connections are also provided. In effect, the circuit module 30 provides a plug-in carrier or holder (such as a key holder, etc.), suitable for engaging a storage receptacle or the like, that has a unique digital registration number. This plug-in carrier or holder may be selectively activated and identified, preferably in conjunction with the lighting, intermittently or otherwise, of an LED or the like, providing the location of the plug-in carrier or holder. As described above, the LED or the like is assembled as part of the storage receptacle, as opposed to the plug-in carrier or holder.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the present invention and are intended to be covered by the following claims.

1. An electronic activation and identification module, comprising:
a holder device configured to hold an object of interest;
a digital device coupled to the holder device, wherein the digital device has a unique digital registration number;
a storage receptacle configured to selectively receive the holder device;
a light-emitting source coupled to the storage receptacle and associated with the holder device; and
an electrical power source.

2. The electronic activation and identification module of claim 1, wherein the digital device comprises a microprocessor.

3. The electronic activation and identification module of claim 2, wherein the digital device comprises the microprocessor disposed within a protective housing.

4. The electronic activation and identification module of claim 1, wherein the light-emitting source comprises a light-emitting diode.

5. The electronic activation and identification module of claim 1, wherein the digital device is in electrical communication with a serial data bus.

6. The electronic activation and identification module of claim 1, wherein the light-emitting source provides an identifying position signal indicating when the holder device is one of being received by the storage receptacle and not being received by the storage receptacle.

7. The electronic activation and identification module of claim 1, further comprising a microprocessor operable for selectively illuminating the light-emitting source.

8. An electronic activation and identification method, comprising:
providing a holder device configured to hold an object of interest;
providing a digital device coupled to the holder device, wherein the digital device has a unique digital registration number;
providing a storage receptacle configured to selectively receive the holder device;
providing a light-emitting source coupled to the storage receptacle and associated with the holder device; and
providing an electrical power source.

9. The electronic activation and identification method of claim 8, wherein the digital device comprises a microprocessor.

10. The electronic activation and identification method of claim 9, wherein the digital device comprises the microprocessor disposed within a protective housing.

11. The electronic activation and identification method of claim 8, wherein the light-emitting source comprises a light-emitting diode.

12. The electronic activation and identification method of claim 8, wherein the digital device is in electrical communication with a serial data bus.

13. The electronic activation and identification method of claim 8, wherein the light-emitting source provides an identifying position signal indicating when the holder device is one of being received by the storage receptacle and not being received by the storage receptacle.

14. The electronic activation and identification method of claim 8, further comprising providing a microprocessor operable for selectively illuminating the light-emitting source.
